(19) United States
(12) Patent Application Publication
(10) Pub. No.: US 2007/0216686 A1
(43) Pub. Date: Sep. 20, 2007

(54) PIXEL STRUCTURE AND LIQUID CRYSTAL DISPLAY PANEL

(75) Inventor: Chun Huan Chang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Au Optronics Corporation, Hsinchu (TW)

(21) Appl. No.: 11/557,954

(22) Filed: Nov. 8, 2006

(30) Foreign Application Priority Data
Mar. 16, 2006 (TW) 95108958

(51) Int. Cl. G06T 11/20

(52) U.S. Cl. 345/441

(57) ABSTRACT

A pixel structure is provided. The pixel structure includes a substrate, a scan line, a data line, an active device, a pixel electrode and a common line. The active device is electrically connected to the scan line and the data line. The pixel electrode is electrically connected to the active device. The pixel electrode is disposed above the data line and crosses over the data line. The common line is disposed below the pixel electrode, and the pixel electrode covers a part of the common line.

### CROSS-REFERENCE TO RELATED APPLICATION

This application claims the priority benefit of Taiwan application serial no. 95108958, filed Mar. 16, 2006. All disclosure of the Taiwan application is incorporated herein by reference.

### BACKGROUND OF THE INVENTION

1. Field of Invention

The present invention relates to a pixel structure and a display panel, and more particularly, to a pixel structure and a liquid crystal display panel for improving the display quality of the liquid crystal display panel.

2. Description of Related Art

In order to suit the modem lifestyle, video or image devices are gradually becoming thin and light. Though the conventional cathode ray tube (CRT) display has advantages, the CRT display has a large volume and occupies a lot of space due to the electron gun therein. When the CRT display outputs images, radiant rays are emitted, causing problems such as eye damage. Therefore, with optoelectronic technology and semiconductor manufacturing technology, flat panel displays (FPDs) such as the liquid crystal display have been developed and have gradually become mainstream products in the market.

FIG. 1 is a top view of a conventional thin film transistor array substrate. Referring to FIG. 1, a conventional thin film transistor array substrate 10 comprises a glass substrate 11 and a plurality of pixel structures 15 disposed on the glass substrate 11. Each of the pixel structures 15 comprises a scan line 12, a data line 13, a common line 14, a thin film transistor 16 and a transmissive conductive electrode 17 (e.g. indium tin oxide (ITO)). The thin film transistor 16 is electrically connected to the corresponding scan line 12 and data line 13. The transmissive conductive electrode 17 is electrically connected to the thin film transistor 16. Furthermore, the transmissive conductive electrode 17 and the common line 14 therebelow form a storage capacitance.

After a liquid crystal layer is filled between the thin film transistor array substrate 10 and a color filter substrate (not shown), a liquid crystal display panel (not shown) is thus formed. However, since each data line 13 crosses over the corresponding common line 14, a crosstalk occurs between each data line 13 and the corresponding common line 14. Thus, the voltage level of each transmissive conductive electrode 17 is interfered when different signals are transformed in the corresponding data line 13, and further, the display quality of the liquid crystal display panel is deteriorated.

In order to solve the above problems, another conventional film transistor array substrate design is provided. FIG. 2 is a top view of another conventional thin film transistor array substrate. Referring to FIG. 2, in the conventional thin film transistor array substrate 20, common lines 24 are disposed over the glass substrate 11 parallel with the data lines 13, thus avoiding the crosstalk occurring between the data lines 13 and the common lines 24. Furthermore, a high aperture ratio layout is employed to design the thin film transistor array substrate 20, such that a transmissive conductive electrode 27 of each pixel unit 25 is partially overlaid on the adjacent data lines 13.

Since each of the transmissive conductive electrodes 27 is partially overlaid on adjacent data lines 13, parasitic capacitances Cpd are generated between each transmissive conductive electrode 27 and the data line 13 on the left side thereof. Additionally, parasitic capacitances Cpd′ are generated between each transmissive conductive electrode 27 and the data line 13 on the right side thereof. The values of the parasitic capacitances C_{pd} and C_{pd}′ depend on the overlay areas of the transmissive conductive electrode 27 and the adjacent data lines 13.

Though the overlay areas of each transmissive conductive electrode 27 and the adjacent data lines 13 are equal according to the layout of each mask, in practical fabrication, an overlay shift is generated in each lithography process. The overlay shift is especially prone to occur when fabricating large-size panels. When the overlay shift of a partial region of the transmissive conductive electrode 27 and adjacent data lines 13 is too large, in the dot inversion, due to the big value difference between parasitic capacitances C_{pd} and C_{pd}′ in single pixel structure, capacitance coupling effects of different polarities cannot be offset. Therefore, the liquid crystal display panel (not shown) fabricated by the thin film transistor array substrate 20 may display strips or mura may occur in the same grayscale picture.

### SUMMARY OF THE INVENTION

In view of the above, an object of the present invention is to provide a pixel structure and a liquid crystal display panel for diminishing the crosstalk of the active device array substrate.

Another object of the present invention is to provide a pixel structure and a liquid crystal display panel for eliminating the mura of the liquid crystal display panel.

In order to achieve the above or other objects, the present invention provides a pixel structure, which comprises a substrate, a scan line, a data line, an active device, a pixel electrode and a common line. The active device is electrically connected to the scan line and the data line. The pixel electrode is electrically connected to the active device, and is disposed above the data line and crosses over the data line. The common line is disposed below the pixel electrode, and the pixel electrode covers a part of the common line.

In an embodiment of the present invention, the abovementioned pixel structure further comprises a planarization layer disposed between the pixel electrode and the data line.

In an embodiment of the present invention, the data line of the abovementioned pixel structure is parallel with the common line.

In an embodiment of the present invention, the pixel electrode of the abovementioned pixel structure has a plurality of openings disposed above the data line. Furthermore, the pixel structure further comprises a light shielding layer disposed below the data line.

The present invention further provides a liquid crystal display panel, which comprises an active device array substrate, a color filter substrate and a liquid crystal layer. The liquid crystal layer is disposed between the active device array substrate and the color filter substrate. The active device array substrate comprises a first substrate, a plurality of scan lines, a plurality of data lines, a plurality of active devices, a plurality of pixel electrodes and a plurality of common lines. The scan lines and the data lines are disposed over the first substrate. The active devices are disposed over the first substrate, and each of the active devices is electrically connected to one of the scan lines and one of the data lines. The pixel electrode is disposed over the first substrate, and each of the pixel electrodes is electrically connected to one of the active devices. The pixel electrodes are disposed above the data lines and cross over the data lines. The common lines are disposed over the first substrate and below the pixel electrodes, and at least two sides of each common line are respectively covered by two adjacent pixel electrodes. The color filter substrate comprises a second substrate and a color filter array disposed over the second substrate. The color filter array comprises a black matrix and a color filter film.

In a liquid crystal display panel according to an embodiment of the present invention, the active device array substrate further comprises a planarization layer disposed between the pixel electrode and the data line.

In an embodiment of the present invention, the data lines of the liquid crystal display panel are parallel with the common lines.

In an embodiment of the present invention, each pixel electrode of the active device array substrate has a plurality of openings disposed above the data line. Furthermore, the black matrix of the color filter substrate is aligned with the data lines of the active device array substrate. The linewidth of the black matrix of the color filter substrate falls in a range of, for example, 6 μm˜20 μm, but is not limited to this range. The black matrix is further aligned with the common lines of the active device array substrate.

In a liquid crystal display panel according to an embodiment of the present invention, the active device array substrate further comprises at least a light shielding layer disposed below each data line. Furthermore, the black matrix of the color filter substrate is aligned with the data lines of the active device array substrate. The black matrix is further aligned with the common lines of the active device array substrate.

In view of the above, in the pixel structure of the present invention, the data line is not overlaid on the common line, so that a crosstalk does not occur between the data line and the common line. Furthermore, the overlay areas of each pixel electrode and the data line are the same and may not change with the overlay shift of the processes. Therefore, in the active device array substrate fabricated from the pixel structure of the present invention, each pixel electrode is maintained at a predetermined grayscale voltage level. When the active device array substrate is further applied in a liquid crystal display panel, the mura of the liquid crystal display panel can be greatly reduced, and better display quality can be attained.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a top view of the conventional thin film transistor array substrate.

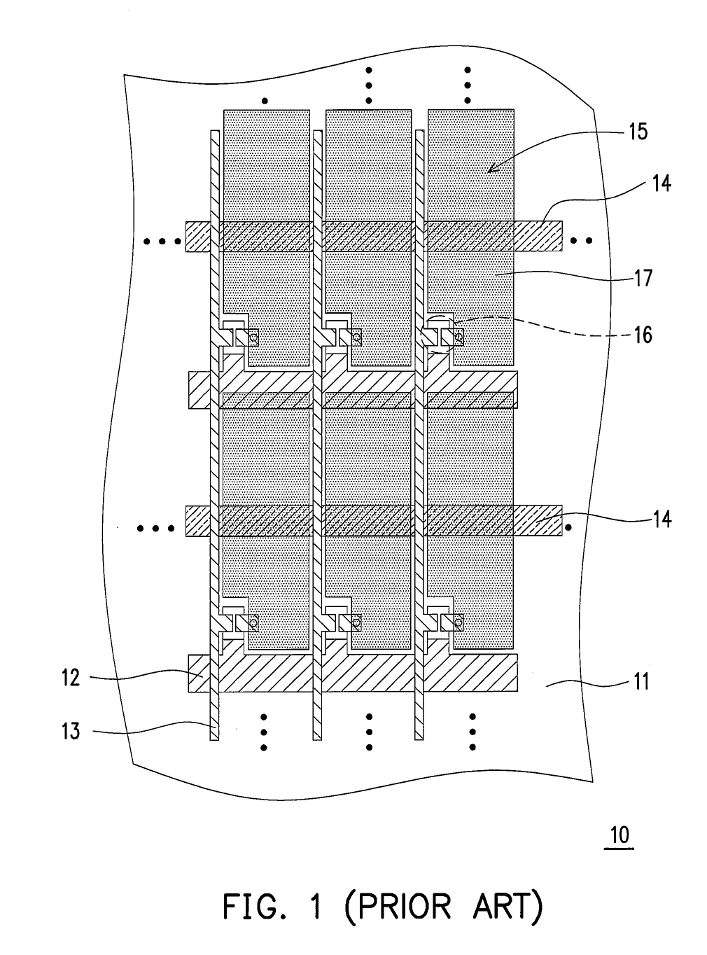

FIG. 2 is a top view of another conventional thin film transistor array substrate.

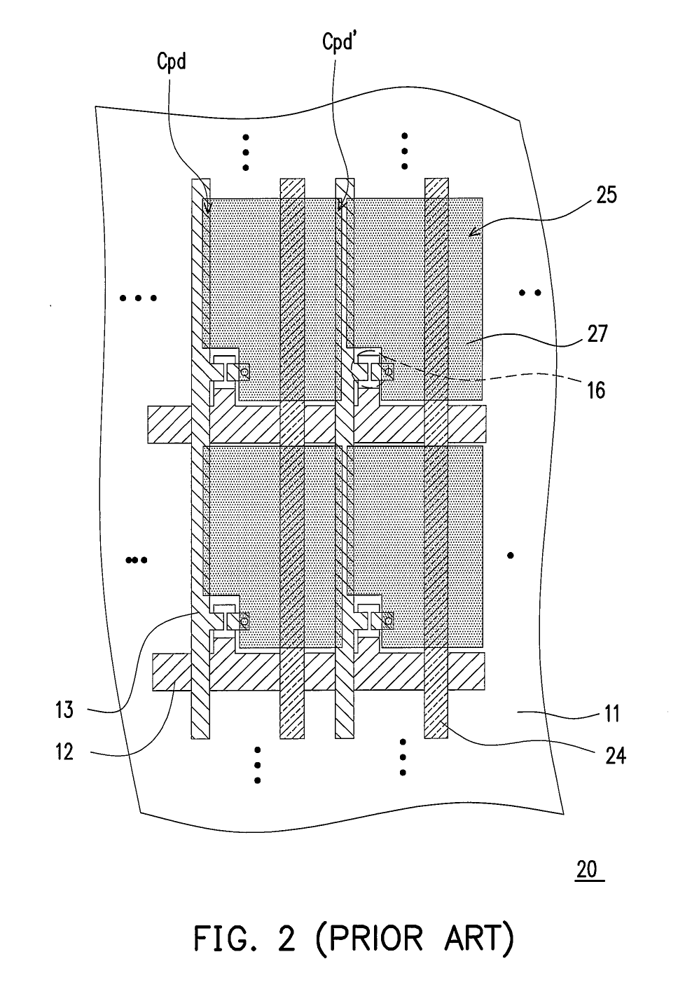

FIG. 3A is a schematic cross sectional view of the liquid crystal display panel according to a first embodiment of the present invention.

FIG. 3B is a partial top view of the active device array substrate of the liquid crystal display panel of FIG. 3A.

FIG. 4A is a schematic cross sectional view of the liquid crystal display panel according to the second embodiment of the present invention.

FIG. 4B is a partial top view of the active device array substrate of the liquid crystal display panel of FIG. 4A.

FIG. 5A is a schematic cross sectional view of the liquid crystal display panel according to the third embodiment of the present invention.

FIG. 5B is a partial top view of the active device array substrate of the liquid crystal display panel of FIG. 5A.

FIG. 5C is a schematic cross sectional view of the active device array substrate along the section line F-F′ of FIG. 5B.

### DESCRIPTION OF EMBODIMENTS

### The First Embodiment

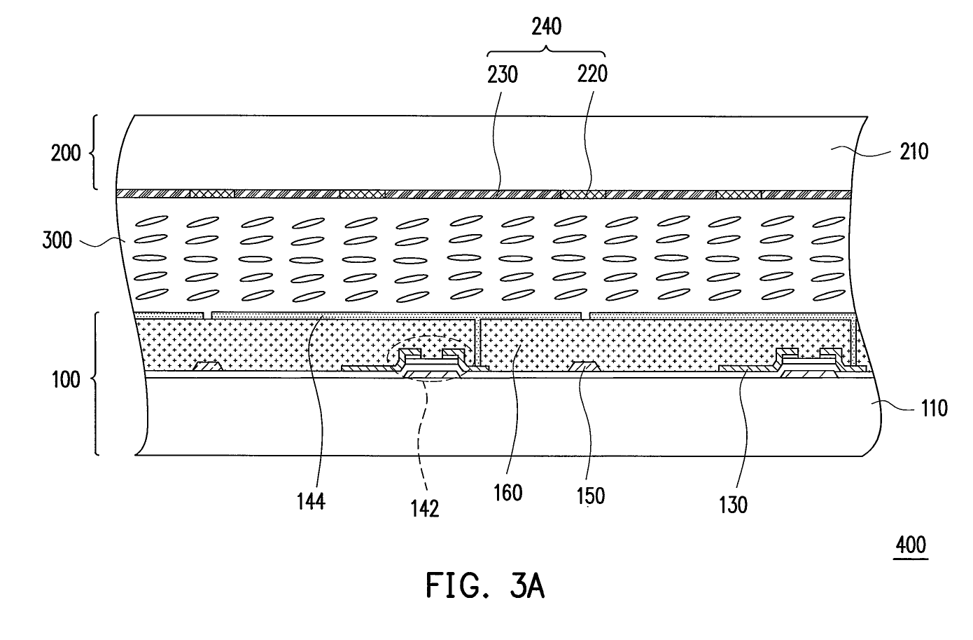

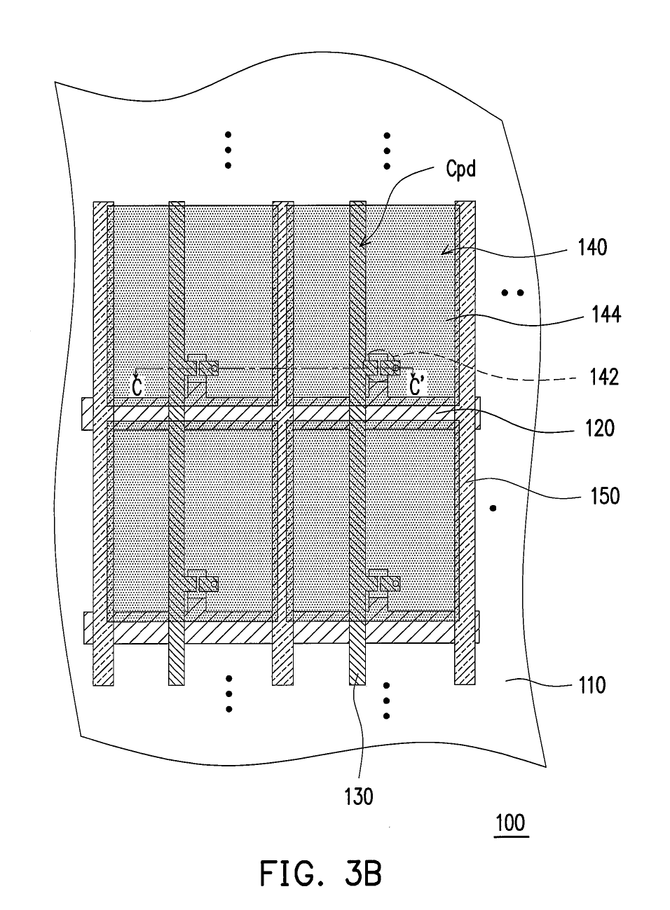

FIG. 3A is a schematic cross sectional view of the liquid crystal display panel according to a first embodiment of the present invention. FIG. 3B is a partial top view of the active device array substrate of the liquid crystal display panel of FIG. 3A, in which the active device array substrate in FIG. 3A is a schematic cross sectional view taken along the section line C-C′ of FIG. 3B. Referring to FIG. 3A and FIG. 3B together, the liquid crystal display panel 400 of the embodiment comprises an active device array substrate 100, a color filter substrate 200 and a liquid crystal layer 300. The liquid crystal layer 300 is disposed between the active device array substrate 100 and the color filter substrate 200.

The active device array substrate 100 comprises a first substrate 110, a plurality of scan lines 120, a plurality of data lines 130, a plurality of active devices 142, a plurality of pixel electrodes 144 and a plurality of common lines 150. The first substrate 110 is, for example, a glass substrate, a quartz substrate or another substrate made of transmissive material. The scan lines 120 are, for example, aluminum alloy lines or other lines made of conductive material, and are disposed over the first substrate 110 in parallel. The data lines 130 are, for example, chromium lines, aluminum alloy lines or other lines made of conductive material, and are also disposed over the first substrate 110 in parallel but perpendicular to the scan lines 120. The active devices 142 are, for example, thin film transistors or other ti-polar switching devices disposed over the first substrate 110. Each of the active devices 142 is adjacent to the intersection of a scan line 120 and a data line 130 and is electrically connected to the scan line 120 and the data line 130. The pixel electrodes 144 are disposed over the first substrate 110, and each of the pixel electrodes 144 is electrically connected to one of the active devices 142. Each of the pixel electrodes 144 is, for example, a transmissive electrode, reflective electrode or a transflective electrode, and the material thereof is, for example, indium tin oxide (ITO), indium zinc oxide (IZO), metal, or another transmissive or nontransmissive conductive material. Furthermore, the pixel electrodes 144 are disposed above the data lines 130 and cross over the data lines 130. The common lines 150 are chromium lines, aluminum alloy lines or other lines made of proper conductive material, and are disposed over the first substrate 110 in parallel with the data lines 130 and below the pixel electrodes 144. Each of the common lines 150 is correspondingly disposed between two adjacent pixel electrodes 144, and the two adjacent pixel electrodes 144 respectively cover at least two sides of the corresponding common line 150.

The color filter substrate 200 comprises a second substrate 210 and a color filter array 240. The second substrate 210 is, for example, a glass substrate, a quartz substrate or another substrate made of transmissive material. The color filter array 240 is disposed over the second substrate 210, and comprises a black matrix 220 and a color filter film 230. The black matrix 220 is made of, for example, chromium, black resin or another light shielding material. The color filter film 230 is made of, for example, color resin or another color dye.

It should be noted that the scan lines 120, the data lines 130, the active devices 142, the pixel electrodes 144 and the common lines 150 constitute pixel structures 140. In other words, each pixel structure 140 comprises a scan line 120, a data line 130, an active device 142, a pixel electrode 144 and a common line 150.

According to an embodiment of the invention, as shown in FIG. 3B, the data lines 130 and the common lines 150 of the active device array substrate 100 are parallel. Furthermore, as shown in FIG. 3A, the active device array substrate 100 further comprises a planarization layer 160 that is made of, for example, an organic insulating material or an inorganic insulating material, and the planarization layer 160 is disposed between the pixel electrodes 144 and the data lines 130.

In each pixel structure 140, since the data line 130 is not overlaid on the common line 150, a cross-talk does not occur between the data line 130 and the common line 150. Thus, the grayscale voltage level of the pixel electrode 144 is not interfered when different signals are transformed in the data line 130, i.e. the display quality of the liquid crystal display panel 400 is improved. Furthermore, according to the design of the pixel structure 140, the pixel electrode 144 is disposed above the data line 130 and crosses over the data line 130. As such, though an overlay shift is generated among lithography processes during fabricating the active device array substrate 100, the overlay area of each pixel electrode 144 and the corresponding data line 130 is identical. The values of the parasitic capacitance C_{pd} generated between different pixel electrodes 144 and the data line 130 corresponding thereto are the same. As such, in the active device array substrate 100, all of the pixel electrodes 144 can achieve a predetermined grayscale voltage level, and thus the mura of the liquid crystal display panel can be greatly reduced and further the display quality can be enhanced. Furthermore, a better process window between the pixel electrodes 144 and the data lines 130 is provided.

### The Second Embodiment

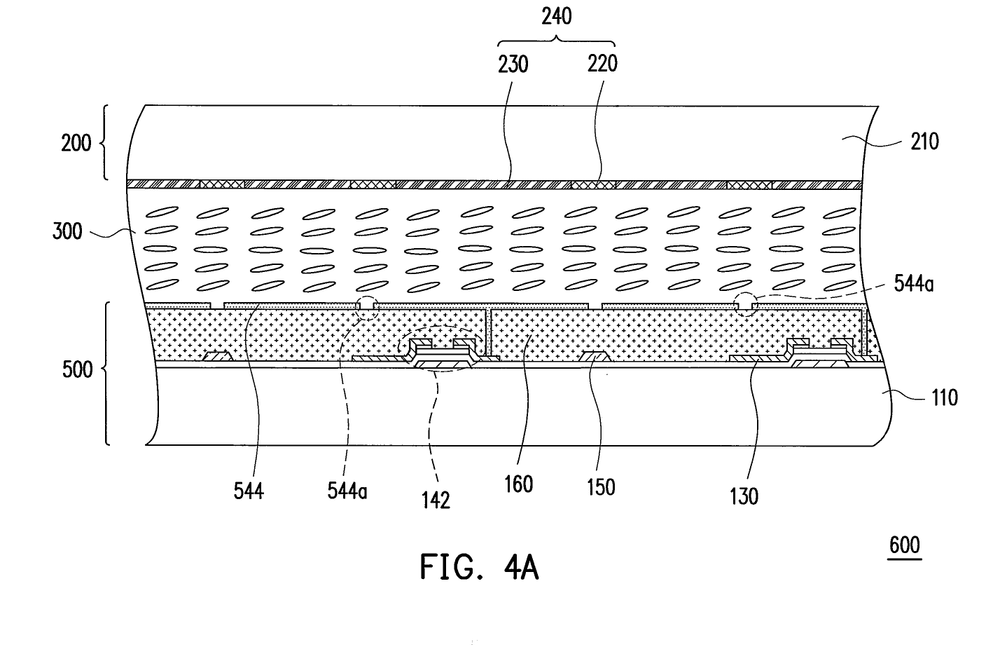

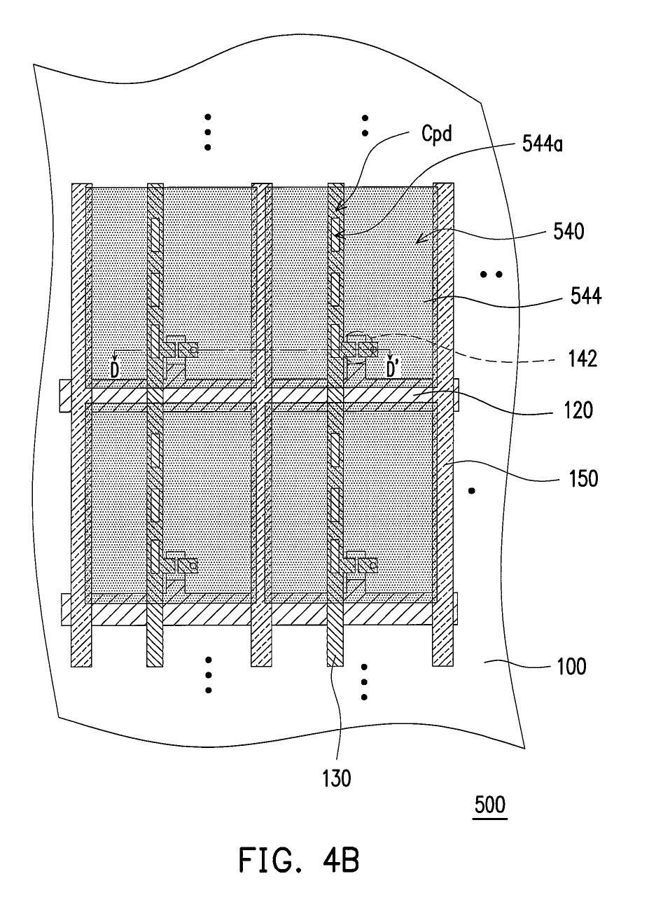

FIG. 4A is a schematic cross sectional view of the liquid crystal display panel according to the second embodiment of the present invention. FIG. 4B is a partial top view of the active device array substrate of the liquid crystal display panel in FIG. 4A, in which the active device array substrate of FIG. 4A is a schematic cross sectional view taken along the section line D-D′ of FIG. 4B. Referring to FIG. 4A and FIG. 4B together, the liquid crystal display panel 600 of the embodiment is similar to the liquid crystal display panel 400 of the first embodiment, but the difference lies in that in the active device array substrate 500, the pixel electrode 544 of each pixel structure540 has a plurality of openings 544a disposed above the data line 130. More specifically, the openings 544a are distributed in a range of the line-width of the data line 130. As such, the overlay area of each of the pixel electrode 544 and data line 130 can be reduced, such that the parasitic capacitance C_{pd} between pixel electrode 544 and the data line 130 is accordingly reduced, thereby reducing the vertical crosstalk.

As described above, in the embodiment, in order to prevent a light leakage occurring over the data lines 130 or common lines 150 of the liquid crystal display panel 600, the black matrix 220 of the color filter substrate 200 is aligned with the data lines 130 of the active device array substrate 500, and the black matrix 220 is also aligned with the common lines 150, i.e., the black matrix 220 of the color filter substrate shields the common lines 150 in addition to the data lines 130. The line-width of the black matrix 220 falls in a range of, for example, 6 μm˜20 μm, but is not limited to this range.

### The Third Embodiment

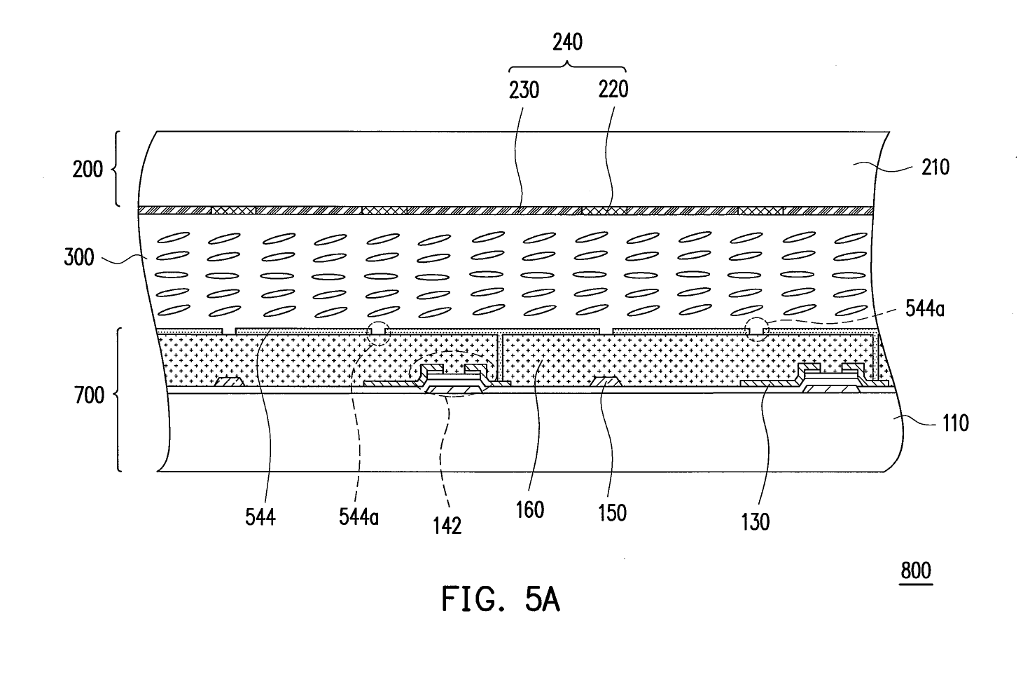

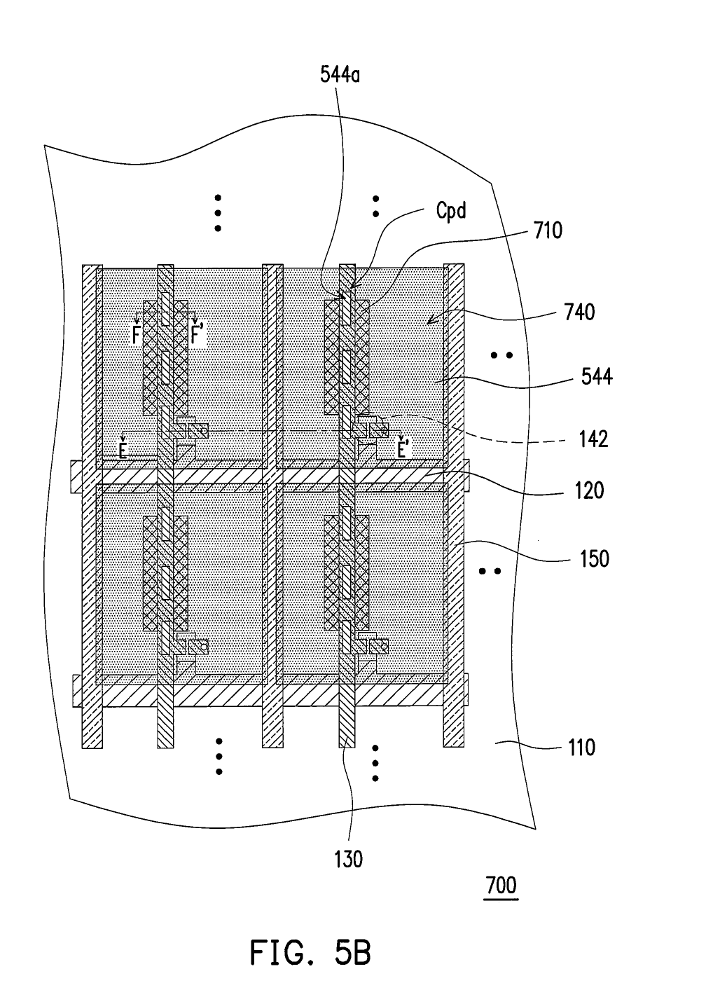

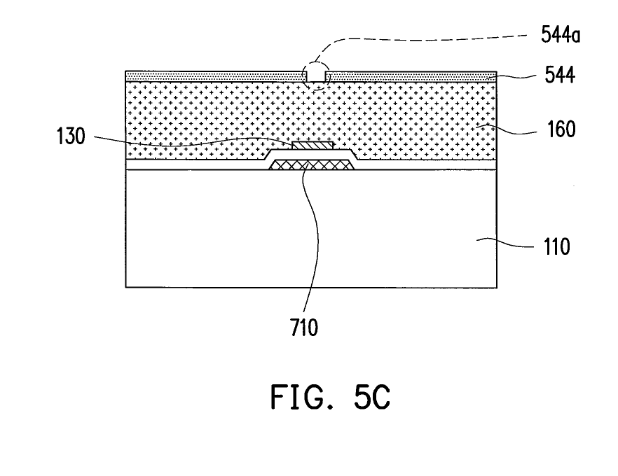

FIG. 5A is a schematic cross sectional view of the liquid crystal display panel according to the third embodiment of the present invention. FIG. 5B is a partial top view of the active device array substrate of the liquid crystal display panel in FIG. 5A, in which the active device array substrate of FIG. 5A is a schematic cross sectional view taken along the section line E-E′ of FIG. 5B. FIG. 5C is a schematic cross sectional view of the active device array substrate taken along the section line F-F′ of FIG. 5B. Referring to FIG. 5A and FIG. 5C together, the liquid crystal display panel 800 is a variation of the liquid crystal display panel 600 of the second embodiment. In the liquid crystal display panel 800, each data line 130 of the active device array substrate 700 further comprises at least a light shielding layer 710 therebelow. The light shielding layer 710 is disposed below the data lines 130 to shield the light leakage herein. The light shielding layer 710 is, for example, a chromium layer, an aluminum layer or another light shielding material layer. According to the embodiment, the black matrix 220 of the color filter substrate 200 is aligned with the data lines 130 of the active device array substrate 700, and the black matrix 220 is also aligned with the common lines 150, i.e. the black matrix 220 shields the common lines 150 in addition to the data lines 130. In the embodiment, the line-width of the black matrix 220 falls in a range of, for example, 6 μm˜15 μm. Since a light shielding layer 710 is disposed below the data lines 130, the line-width of the black matrix 220 correspondingly disposed above the data lines 130 can be reduced, thus raising the aperture ratio.

With the light shielding layer 710 of the active device array substrate 700 and the black matrix 220 of the color filter substrate 200, the light leakage above the data lines 130 or common lines 150 of the liquid crystal display panel 800 may be shielded, such that the liquid crystal display panel 800 has better display quality.

In view of the above, the pixel structure and the liquid crystal display panel of the present invention has at least the following advantages.

1. In the pixel structure of the present invention, the data lines and the common lines are parallel, i.e. the data lines are not overlaid on the common lines, and thus the crosstalk may not occur between the data lines and the common lines. Therefore, the liquid crystal display panel fabricated by the pixel structure has favorable display quality.

2. The design of the pixel structure of the present invention allows the overlay areas of different pixel electrodes and the corresponding data lines being the same, so that the overlay area of each pixel electrode and the corresponding data line may not be changed due to the overlay shift in the processes. Therefore, if the pixel structure is adopted to fabricate an active device array substrate, a better process window between the pixel electrodes and the data lines is provided.

3. In the pixel structure of the present invention, the pixel electrodes are disposed above the corresponding data lines and cross over the corresponding data lines, such that the overlay areas of different pixel electrodes and the corresponding data line are the same. Therefore, in the active device array substrate fabricated by the pixel structure of the present invention, each pixel electrode can be normally charged (or discharged) to a predetermined electric charge quantity. When the active device array substrate is further applied in a liquid crystal display panel, the mura of the liquid crystal display panel can be greatly reduced, thereby favorable display quality is provided.

4. In the second embodiment of the present invention, each pixel electrode has a plurality of openings, so the overlay area of each pixel electrode and the corresponding data line can be reduced in addition, the parasitic capacitance between each pixel electrode and the corresponding data line can also be reduced, thus diminishing the vertical crosstalk.

5. In the third embodiment of the present invention, at least one light shielding layer is further disposed below each of the data lines to shield the light leakage region. Therefore, in the embodiment, the line-width of the black matrix can be reduced, thus partially raising the aperture ratio.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, comprising:
a substrate;
a scan line and a data line disposed over the substrate;
an active device electrically connected to the scan line and the data line;
a pixel electrode electrically connected to the active device, wherein the pixel electrode is disposed above the data line and crosses over the data line; and
a common line disposed below the pixel electrode, wherein the pixel electrode covers a part of the common line.

2. The pixel structure of claim 1, further comprising a planarization layer disposed between the pixel electrode and the data line.

3. The pixel structure of claim 1, wherein the data line is parallel with the common line.

4. The pixel structure of claim 1, wherein the pixel electrode has a plurality of openings disposed above the data line.

5. The pixel structure of claim 4, further comprising a light shielding layer disposed below the data line.

6. A liquid crystal display panel, comprising:
an active device array substrate, comprising:
a first substrate;
a plurality of scan lines and a plurality of data lines disposed over the first substrate;
a plurality of active devices disposed over the first substrate, and each of the active devices being electrically connected to one of the scan lines and one of the data lines;
a plurality of pixel electrodes disposed over the first substrate, and each of the pixel electrodes being electrically connected to one of the active devices, wherein the pixel electrodes are disposed above the data lines and cross over the data lines;
a plurality of common lines disposed over the first substrate and below the pixel electrodes, and each of the common lines being correspondingly disposed between two adjacent pixel electrodes, wherein the two adjacent pixel electrodes respectively cover at least two sides of each common line;
a color filter substrate, comprising:
a second substrate;
a color filter array disposed above the second substrate and comprising a black matrix and a color filter film; and
a liquid crystal layer disposed between the color filter substrate and the active device array substrate.

7. The liquid crystal display panel of claim 6, wherein the active device array substrate further comprises a planarization layer disposed between the pixel electrodes and the data lines.

8. The liquid crystal display panel of claim 6, wherein the data lines are parallel with the common lines.

9. The liquid crystal display panel of claim 6, wherein each pixel electrode of the active device array substrate has a plurality of openings disposed above the corresponding data line.

10. The liquid crystal display panel of claim 9, wherein the black matrix of the color filter substrate is aligned with the data lines of the active device array substrate.

11. The liquid crystal display panel of claim 10, wherein the line-width of the black matrix of the color filter substrate falls in a range of 6 μm˜20 μm.

12. The liquid crystal display panel of claim 10, wherein the black matrix of the color filter substrate is further aligned with the common lines of the active device array substrate.

13. The liquid crystal display panel of claim 9, wherein the active device array substrate further comprises at least a light shielding layer disposed below each data line.

14. The liquid crystal display panel of claim 13, wherein the black matrix of the color filter substrate is aligned with the data lines of the active device array substrate.

15. The liquid crystal display panel of claim 14, wherein the black matrix of the color filter substrate is further aligned with the common lines of the active device array substrate.
